(19) United States
(12) Patent Application Publication
(10) Pub. No.: US 2011/0258564 A1
(43) Pub. Date: Oct. 20, 2011

(54) METHOD FOR AUTOMATICALLY RELOCATING AND DISPLAYING MULTIPLE FILES

(75) Inventors: Chee-Chun LEUNG, Tao Yuan Shien (TW); Ming-Chuan Hu, Zhonghe City (TW); Tai-Ta Chou, Yonghe City (TW)

(73) Assignee: Quanta Computer Inc., Tao Yuan Shien (TW)

(21) Appl. No.: 12/939,507

(22) Filed: Nov. 4, 2010

(30) Foreign Application Priority Data
Apr. 14, 2010 (TW) 99111705

(51) Int. Cl. G06F 3/14

(52) U.S. Cl. 715/761

(57) ABSTRACT

A method for automatically relocating and displaying multiple files includes following steps. A first file is opened. When the first file is opened, whether there exists a second file opened and displayed on a first display is detected. If there exists a second file opened and displayed on a first display, the second file is moved and displayed on a second display, and the first file is displayed on the first display.

This application claims the benefit of Taiwan application Serial No. 99111705, filed Apr. 14, 2010, the subject matter of which is incorporated herein by reference.

### BACKGROUND OF THE INVENTION

1. Field of the Invention

The invention relates in general to a method for automatically relocating and displaying multiple files, and more particularly to a highly convenient method for automatically relocating and displaying multiple files.

2. Description of the Related Art

As the technology of the panel technology is getting more and more matured, liquid crystal display (LCD) has gradually replaced conventional cathode ray tube display and become widely used in various electronic devices or appliances. Also, as the technology advances, the LCD becomes cheaper and cheaper, and the multi-display technology is widely used in desktop computer and various portable electronic devices.

However, when the user would like to open and process multiple files simultaneously, the user has to manually relocate different files to respective displays, which is indeed very inconvenient to the user.

### SUMMARY OF THE INVENTION

The invention is directed to a method for automatically relocating and displaying multiple files. Through an auto-control method, multiple files are relocated and displayed on different displays, hence providing more convenience to the user.

According to a first aspect of the present invention, a method for automatically relocating and displaying multiple files is provided. The method includes the following steps. A first file is opened. When the first file is opened, whether there exists a second file opened and displayed on a first display is detected. If there exists a second file opened and displayed on a first display, the second file is moved and displayed on a second display, and the first file is displayed on the first display.

According to a second aspect of the present invention, a method for automatically relocating and displaying multiple files is provided. The method includes the following steps. A first file is opened and whether the first file is already opened and displayed on a first display is judged. If the first file is already opened and displayed on the first display, then the first file is moved and displayed on a second display, and the first file is copied as a temporary file which is then displayed on a first display.

According to a third aspect of the present invention, a method for automatically relocating and displaying multiple files is provided. The method includes the following steps. When a first file displayed on a first display is closed, whether the first file is a temporary file is judged, and if yes, then the temporary file is saved. Whether there exists a second file opened and displayed on a second display is judged. If there exists a second file opened and displayed on the second display, then the first file is closed, and the second file is moved and displayed on the first display.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a flowchart of an example of the method for automatically relocating and displaying multiple files according to a preferred embodiment of the invention;

FIG. 2 shows a flowchart of another example of the method for automatically relocating and displaying multiple files according to a preferred embodiment of the invention.

### DETAILED DESCRIPTION OF THE INVENTION

The invention provides a method for automatically relocating and displaying multiple files. Through an auto-control method, multiple files are automatically relocated and displayed in a multi-display environment, hence providing more convenience to the user.

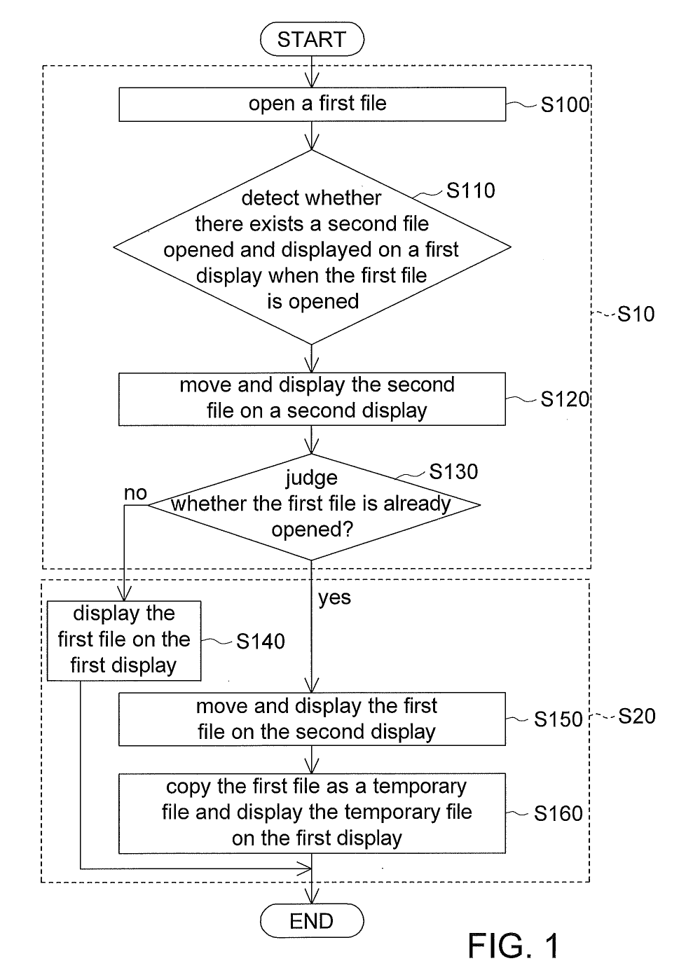

Referring to FIG. 1, a flowchart of an example of the method for automatically relocating and displaying multiple files according to a preferred embodiment of the invention is shown. The method for automatically relocating and displaying multiple files of the present embodiment of the invention is used in a multi-display environment and can be implemented by an application program or a microprocessor, and no particular restriction is imposed in the invention. Firstly, the method begins at step S100, a first file is opened. Next, the method proceeds to step S110, whether there exists a second file opened and displayed on a first display is detected when the first file is opened. That is, whether there is any other files being used is detected when the first file is opened.

If there exists a second file opened and displayed on a first display, then the method proceeds to step S120, the second file is moved and displayed on a second display. The second file can be displayed on the second display in the manner of a full-screen display or a partial-screen display, and no particular restriction is imposed in the invention. Thus, when the user would like to open and process more than two files at the same time, the application program or the microprocessor will automatically relocate different files to respective displays without bothering the user to manually relocate these files, which is very convenient to the user.

Then, the method proceeds to step S130, whether the first file is already opened is judged. If the first file is not yet opened, then the process proceeds to step S140, the first file is displayed on the first display. If the first file is already opened, then the method proceeds to step S150, the first file is moved and displayed on the second display. Meanwhile, if the second display displays the second file before step S150 is performed, then the second file can be moved and displayed on a third display, the first file can directly cover the second file to be displayed on the second display, or the first file and the second file can both be displayed on the second display side by side.

Afterwards, the method proceeds to step S160, the first file is copied as a temporary file, and the temporary file is displayed on the first display. Thus, the user can edit the temporary file, and, at the same time, compare the temporary file to the first file displayed on the second display. Thus, the user can open the first file in two windows without having to copy the first file first and then save the first file in another file name. Through the use of an application program or a microprocessor, the user can save a lot of tedious manual operations.

In the flowchart of the method for automatically relocating and displaying multiple files illustrated in FIG. 1, the blocks S10 and S20 illustrated in dotted lines can be independently implemented. When the block S10 is independently implemented, if no second file opened and displayed on the first display is detected in step S110, then the first file will be directly displayed on the first display. In step S120, after the second file is moved and displayed on the second display, the first file will be displayed on the first display.

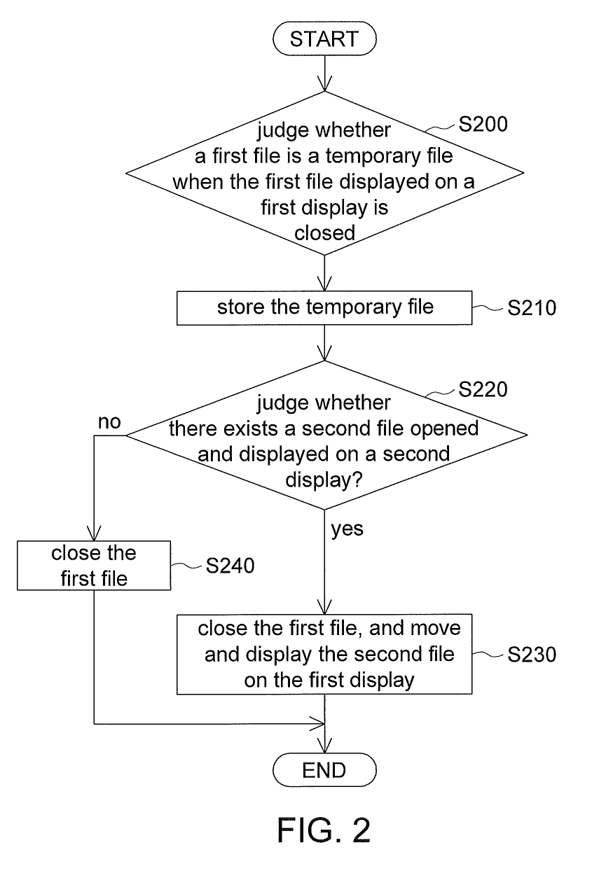

Referring to FIG. 2, a flowchart of another example of the method for automatically relocating and displaying multiple files according to a preferred embodiment of the invention. In FIG. 2, if the user would like to close the first file, then in step S200, whether the first file is a temporary file is judged when a first file displayed on a first display is closed. If the first file is a temporary file, then the method proceeds to step S210, the temporary file is stored. In step S210, the temporary file can be saved as a new file or can directly cover its corresponding original file.

Then, the method proceeds to step S220, whether there exists a second file opened and displayed on a second display is judged. If there exists a second file opened and displayed on the second display, then the process proceeds to step S230, the first file is closed, and the second file is moved and displayed on the first display. If there does not exist a second file opened and displayed on the second display, then the method proceeds to step S240, the first file is closed.

The method for automatically relocating and displaying multiple files disclosed in the above embodiments of the invention has many advantages exemplified below:

According to the method for automatically relocating and displaying multiple files of the invention, multiple files are automatically displayed in a multi-display environment through an auto-control method. Thus, when the user would like to open and process more than two files at the same time, the application program or the microprocessor will automatically relocate different files to respective displays without bothering the user to manually relocate these files. When the user would like to open the same file on multiple windows, the user can open the same file in multiple windows without having to copy the file first and then save the file in another file name. Through the use of an application program or a microprocessor, the user can save a lot of tedious manual operations.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for automatically relocating and displaying multiple files, comprising:
opening a first file;
detecting whether there exists a second file opened and displayed on a first display when the first file is opened; and
moving and displaying the second file on a second display and displaying the first file on the first display if there exists a second file opened and displayed on the first display.

2. The method for automatically relocating and displaying multiple files according to claim 1, further comprising:
displaying the first file on the first display if there does not exist a second file opened and displayed on the first display.

3. The method for automatically relocating and displaying multiple files according to claim 1, further comprising:
judging whether the first file is already opened; and
displaying the first file on the first display if the first file is not yet opened.

4. The method for automatically relocating and displaying multiple files according to claim 3, further comprising:
moving and displaying the first file on the second display of the first file is already opened; and
copying the first file as a temporary file and displaying the temporary file on the first display.

5. The method for automatically relocating and displaying multiple files according to claim 4, wherein the second file is moved and displayed on a third display.

6. The method for automatically relocating and displaying multiple files according to claim 4, wherein the first file covers the second file, or the first file and the second file are both displayed on the second display.

7. A method for automatically relocating and displaying multiple files, comprising:
opening a first file and judging whether the first file is already opened and displayed on a first display; and
moving and displaying the first file on a second display, copying the first file as a temporary file and displaying the temporary file on a first display if the first file is already opened and displayed on the first display.

8. The method for automatically relocating and displaying multiple files according to claim 7, further comprising:
displaying the first file on the first display if the first file is not yet opened.

9. A method for automatically relocating and displaying multiple files, comprising:
judging whether the first file is a temporary file when a first file displayed on a first display is closed, and storing the temporary file if the first file is a temporary file;
judging whether there exists a second file opened and displayed on a second display; and
closing the first file, and moving and displaying the second file on the first display if there exists a second file opened and displayed on the second display.

10. The method for automatically relocating and displaying multiple files according to claim 9, further comprising:
closing the first file if there does not exist a second file opened and displayed on the second display.
